(19) United States
(12) Patent Application Publication
(10) Pub. No.: US 2013/0186202 A1
(43) Pub. Date: Jul. 25, 2013

(54) DEVICE AND METHOD FOR RECORDING AT LEAST ONE ACCELERATION AND A CORRESPONDING COMPUTER PROGRAM AND A CORRESPONDING COMPUTER-READABLE STORAGE MEDIUM AND ALSO USE OF SUCH A DEVICE

(71) Applicant: Jens Hansen, Berlin (DE)

(72) Inventor: Jens Hansen, Berlin (DE)

(73) Assignee: FIRST SENSOR AG, Berlin (DE)

(21) Appl. No.: 13/812,535

(22) PCT Filed: Jul. 25, 2011
(86) PCT No.: PCT/EP2011/062727

§ 371 Date: Apr. 10, 2013

(30) Foreign Application Priority Data
Jul. 27, 2010 (DE) 10 2010 032 797.2
May 16, 2011 (DE) 10 2011 102 035.0
Jun. 27, 2011 (DE) 10 2011 078 135.8

(51) Int. Cl. G01P 15/02

(52) U.S. Cl. CPC G01P 15/02
USPC 73/514.38

(57) ABSTRACT

A device for measuring acceleration includes a base plate and mass elements connected to the base plate via elastic support elements having measuring points. The support elements of a first and a second mass element are constructed such that the support element of the first and the second mass element have at the measuring points an identical response characteristic for a first acceleration component in a first direction, and mutually different response characteristics for a second acceleration component perpendicular to the first component. The deflection of the measurement points is measured and evaluated. The component in the first and second directions is stepwise eliminated, and the result adjusted for the eliminated component is used for recovering these two components. The result adjusted for the eliminated component is measured as static acceleration and the component acting in the first and the second direction is measured as dynamic acceleration.

The invention relates to a device and a method for detecting at least one acceleration, and a corresponding computer program and a corresponding computer-readable storage medium. The invention further relates to the use of a device suitable for the separate detection of a static and a dynamic acceleration, and a corresponding computer program and a corresponding computer readable storage medium, wherein the use includes, in particular, the analysis and/or control of movements.

Dynamics recorders are increasingly used, whether as a tachograph, for navigation, to control machines, to detect movements in sports activities, even to control computer games.

The scope of the applications, however, fail to address the fact that most movements to be detected are special dynamic situations, since conventional acceleration sensors are not capable of separating so-called static acceleration from dynamic acceleration.

However, both forms of acceleration are superimposed in the general case of a dynamic process. The change of position of the object to be detected relative to the horizontal plane also determines the dynamic process, i.e. its movement.

All conventional sensors can therefore only be used with some limitations, for example, when one form of acceleration is negligible, when an acceleration profile is known, or when its time dependence is so different that electronic filtering is possible, for example when detecting higher frequency vibrations.

The common principle of all conventional acceleration sensors is the measurement of the force generated by acceleration on a resilient or resiliently-mounted mass element. Various embodiments in terms of resolution, range, size, price etc. are commercially available for adaptation to different applications. For example, sensors exist, wherein for example the force acting on the mass element is measured directly—such as a piezo-ceramic element—and others where the force is measured indirectly via deflections of the elastic mass support caused by the force, for example capacitively, inductively, resistively or opto-electronically. Accordingly, the support of the mass element can be implemented in various ways. Conventional approaches include various possible implementations which are highly directional as well as positioning of sensors orthogonally for detecting the spatial components of acceleration forces from any direction.

However, the underlying principle of all embodiments does not permit a distinction between static and dynamic acceleration. It cannot be concluded whether a force acting on the mass element is caused by a movement-induced acceleration or by gravity.

Even simple dynamic events, such as slippage of an object on an inclined plane or a hand gesture, can thereby not be detected.

The two forms of the acceleration can only be separated by employing a gyro system, since the gyro plane represents a reference that is independent of the support plane of the gyroscope and of accelerations.

Due to the highly complex mechanism required for realizing the rotating system, gyro systems are suitable only for a limited number of applications. Even with gyro systems, the angle of the sensor relative to the horizontal plane cannot be detected, because the gyro systems detect only momentary changes in the angle, i.e. relative values rather than absolute values.

Presently, implementing a sensor system for the separation of static and dynamic acceleration using only elements at rest does not appear to be possible.

Processes based on a pulsed light guide path are currently examined for bypassing the gyroscope technology. However, the required length of the light guide is between 200 m and 2 km. These studies demonstrate the great interest in alternative solutions for the gyroscope technology, but have not yet led to practical solutions.

Due to these problems, the possible applications of traditional sensor systems are severely limited.

It is therefore an object of the present invention to provide a device and a method for detecting at least one acceleration, and a corresponding computer program and a corresponding computer readable storage medium, as well as a use of such a device, which overcome the limitations of the conventional solutions and which allow, in particular, to analyze any type of movement and thereby to separate static acceleration components from dynamic acceleration components.

This object is attained with the invention by the features in claims 1, 20, 21, 27 and 35 to 28. Advantageous embodiments of the invention are recited in the dependent claims. Advantageous embodiments are the subject matter of the dependent claims.

Advantageous for the use according to the invention is the use of a special device for separate detection of a static acceleration and a dynamic acceleration, which will be described in more detail below.

According to the invention, a device is used for determining the static and dynamic components of acceleration, with the device having at least one base plate and at least two sensors. The sensors each include a mass element and an elastic support element and are connected via the elastic support element with the at least one base plate. The elastic support elements can be deflected in a plane (sensor plane). The sensors are arranged so that the elastic support elements are deflected in a common plane or in parallel planes under the action of acceleration. The sensors are provided with measurement points for detecting the deflection. The deflection may be measured capacitively, inductively, resistively, opto-electronically or may be measured in any other suitable manner by suitable sensors. According to the invention, the support elements of at least one first and at least one second mass element are constructed such that they have the same response characteristic, i.e. characteristic curve, for an acceleration component which acts in a first direction, but have different characteristic curves for an acceleration component which acts in a direction orthogonal to the first direction. It will be understood that the acceleration directions act in the common deflection plane of the support elements or in planes parallel thereto.

In particular, the first or second direction is the direction in which a static acceleration, such as the gravitational acceleration, acts. The support elements have then different response characteristics regarding acceleration caused by movement and gravity.

In a preferred embodiment, at least two pairs with mass elements are used, each pair having a first and a second support element. Preferably, the at least two pairs are arranged mirror-symmetrically to each other. Advantageously, the axis or line of symmetry may be perpendicular to the base plate.

In a preferred embodiment, three such pairs may be arranged for spatial detection of the accelerations, wherein the three sensor planes are mutually perpendicular.

According to another preferred embodiment, at least one group of support elements with mass elements may be arranged, wherein the group has two first and one second support elements with mass elements or a first and two second support members with mass elements. The duplicate support elements with mass elements of one group are hereby arranged mirror-symmetrically with respect to each other.

In another preferred embodiment, at least two groups of support elements with mass elements are arranged, wherein the groups each have a first and a second support element with a corresponding mass element. At least a portion of the at least two groups is arranged so that the first and second support member with a mass element of a first group are arranged mirror-symmetrically with respect to the first and second support element with a mass element of a second group.

In a preferred embodiment, at least two sensors are provided, which are composed of a base plate and an elastic support (‘support’ will be in the following be used synonymous with ‘support element’) arranged on this base plate, with at least one mass element being attached to the support, and with at least one measuring point being provided on the support, wherein the deflection of the support or the generated force on the support resulting from acceleration forces acting on the mass element is measured electronically or mechanically at the measuring point, with the sensors being aligned in the same direction with respect to acceleration forces in a plane perpendicular to the base plate, and with the sensors being constructed so as to have different response characteristics for movement-induced and gravitational acceleration, wherein the different response characteristics are implemented so that when the sensor output signals are normalized so as to produce the same reactions to acceleration components parallel to the base plate in the direction of the sensor orientation, whereas the response of the sensors to gravitational forces in one quadrant is strongly different, and in the other quadrants is only comparatively slightly different, so that the acceleration components that are identical for the sensors relative to the base plate can be compensated through a mathematical combination of the sensor output signals and that the profile of the gravitational force allows an unambiguous association between gravitational force and the output signal.

With this embodiment, a device for determining having a movement with static and dynamic acceleration components can thus be provided, wherein the device includes at least two sensors with mass elements, which are each arranged on at least one base plate with an elastic support, and which can be deflected in one plane or in parallel planes by acceleration forces, wherein plane(s) enclose(s) with the at least one base plate an angle of 90° and wherein the supports have an identical dynamic or static response characteristic for one of the acceleration forms and a different response characteristic for the other acceleration form, wherein the deflections of the supports, or equivalent physical quantities can be measured at measuring points and computationally processed.

With the described sensor arrangement, on one hand, the movement acceleration components are determined
in the alignment plane of the sensors parallel to the base plate, and perpendicular to the base plate.

On the other hand, the static acceleration caused by the inclination of the base plate relative to the horizontal plane in the alignment plane of the sensors is determined.

Static acceleration components within the context of this application are gravitational accelerations.

Horizontal and vertical accelerations within the context of this application are movement acceleration components as well as dynamic acceleration components.

The plane(s) in which the deflection occurs and/or in which the mass elements oscillate are referred to as sensor plane.

A quadrant is a section of the sensor plane. Specifically, the first quadrant includes angular values from 0° to 90°, the second quadrant angle values from 90° to 180°, the third quadrant angle values from 180° to 270°, the fourth quadrant angle values from 90° to 180°, the third quadrant angle values from 270° to 360°.

A device according to the invention for determining a movement with static and dynamic acceleration components is composed of at least two sensors with their mass elements, which are arranged on at least one base plate and are each provided with an elastic support.

The mass elements can hereby be deflected by acceleration forces in one plane or in parallel planes (sensor plane), wherein the plane(s) may enclose an angle of 90° with the at least one base plate, and wherein the supports have identical dynamic or static response characteristics for one of the acceleration forms and have a different response characteristic for the other acceleration form, and wherein the deflections of the supports or equivalent physical quantities can be measured at measuring points and computationally processed.

When reference is made here to identical response characteristics, this also includes approximate response characteristics.

The mass elements may be supported on a common base plate or, as may be of particular significance for a micromechanical design, on different base plates. It is important that the deflections of the mass bodies occurs in a common plane or in parallel planes and that the base plates of the sensors included in the measuring process for these planes are arranged mutually parallel.

The term base plate hereinafter refers to either a common base plate for the sensors or to mutually parallel base plates.

The angle between the horizontal and the base plate, which is caused by a change in the position of the sensor, is indicated with (α). The angle (α) is, as will be explained below, associated with the gravitational force, which is expressed in the characteristic curves.

This angle (α) is determined for a movement in the X-Y coordinate system. For a three-dimensional movement in the X-Y-Z coordinate system, at least one additional sensor arrangement in the Y-Z coordinate system and/or in the X-Z coordinate system is therefore necessary.

Measured physical quantities that are equivalent to a deflection, which may be measured, for example, capacitively, optically, opto-electronically or inductively, can also be directly measured forces (e.g. piezoelectrically measured forces) or deformations.

It is advantageous for the measuring method, when the lower part of the supports of the sensors is at an angle (β) relative to the base plate, wherein the angle (β) should not be equal to 90°. With this inclination relative to the base plate, the differences between the characteristic curves of the sensors are very different in one quadrant, and only slightly different in the other quadrants. This greatly improves the resolution of the angle information (α).

For measurements in one quadrant and when the vertical acceleration is negligible, two sensors having supports with identical response characteristics for one of the acceleration forms (dynamic or static) and with different response characteristics for the other acceleration form are arranged on the base plate.

For general acceleration measurements in two quadrants, four sensors with mass elements are each arranged on supports in one plane or in parallel planes (sensor planes), wherein each of two respective sensors form a pair, with supports of each pair having identical response characteristics for one of the acceleration forms (dynamic or static) and a different response characteristic for the other acceleration form.

The pairs are preferably arranged on the base plate mirror-symmetrically to each other.

In an advantageous further development, three sensors may be used instead of four sensors with mass elements. One sensor in this embodiment takes on a dual function by forming for the evaluation of the measurement a pair with the respective other sensor.

The sensors for the measurement in one and/or more quadrants are preferably arranged in sensor blocks.

The measured parameters for determining the acceleration components are processed by eliminating acceleration components by way of mathematical processing the simultaneously measured deflections of the sensors, hereinafter referred to as mathematical elimination. This may be performed in the simplest case by subtraction, but is not limited thereto.

When the measured quantities, etc, of the sensors show, for example, deviations in the angle (β), it may be necessary to amplify or otherwise process the measured values, so that the acceleration component to be eliminated is indeed eliminated when forming the respective difference.

For carrying out the method of the invention, a device according to the invention is used, i.e. a device for detecting at least one acceleration, which device includes at least one base plate and at least two mass elements, wherein each mass element is connected with the at least one base plate by an elastic support element, and wherein the support elements can be deflected in a common plane or in parallel planes and wherein the at least two mass elements and/or support elements have each at least one measuring point, and wherein the support elements of at least one first mass element and at least one second mass element are constructed such that the support element of the at least one first mass element and the support element of the at least one second mass element have at the measuring points an identical response characteristic for a first component of an acceleration acting in the common plane or in the parallel planes in a first direction, and have mutually different response characteristics for a second acceleration component acting perpendicular to the first component. According to the invention, to determine the acceleration, in particular a dynamic and a static acceleration, the deflection of at least one first and at least one second mass element and/or support element is measured. This is done in particular by measuring data, such as capacitive, inductive, resistive, optoelectronic values, and the like, that describe the deflection. In particular, the deflection is measured for at least one of the measurement points. According to the invention, the data from at least one first and at least one second mass element and/or support element describing the deflection are analyzed so as to eliminate the component acting in the first direction. This is possible, because the support elements are constructed so that they exhibit an identical response characteristic for the acceleration component acting in the first direction. When the acceleration component acting in the second direction is negligible, the result of the evaluation, i.e. the result adjusted for the acceleration component acting in the first direction, is used to recover the acceleration component acting in the first direction. The result adjusted for the acceleration component acting in the first direction is measured as static acceleration and the component acting in the first direction is measured as dynamic acceleration.

According to the invention, the data may be detected simultaneously. Preferably, the evaluation takes place online.

In a general situation, i.e. when the component acting in the second direction component is not negligible, the aforementioned device is used, which is supplemented by at least one first support element with a mass element and thus has at least three support elements with a mass element. In this embodiment, the support elements of at least two first mass elements and at least one second mass element are constructed such that the support elements of the at least two first mass elements and the support element of the at least one second mass element have at the measuring points the same response characteristic for a first component of an acceleration acting in the common plane or in parallel planes in a first direction and mutually different response characteristics for a second component of the acceleration acting perpendicular to the first component. Data are then always detected which describe the deflection of the at least three support elements, wherein in a first evaluation the data associated with a first of the first support elements and the second support element are evaluated, and in a second evaluation the data associated with a second of the first support elements and the second support element are evaluated. The respective acceleration component acting in the first direction is eliminated in the first and second evaluation. The results of the first and second evaluation, adjusted for the acceleration component acting in the first direction, are then once more evaluated so as to eliminate the acceleration component acting in the second direction. Subsequently, the result adjusted for the acceleration components acting in the first and second direction is used to recover the acceleration component acting in the first and second direction. The result adjusted for the acceleration components acting in the first and second direction is measured as static acceleration and the components acting in the first and second direction are measured as dynamic acceleration.

In another embodiment, at least two second support elements may be provided with a mass element, wherein at least some of the at least two second support elements are arranged mirror-symmetrically with respect to each other.

In a preferred embodiment of the method, least two sensors with mass elements may be provided for determining a movement with static and dynamic acceleration components, which are each arranged on at least one base plate with an elastic support, and which can be deflected by acceleration forces in one plane or in parallel planes oriented perpendicular to the base plate, wherein the supports have identical dynamic or static response characteristics for one of the acceleration forms and have a different response characteristic for the other acceleration form, and wherein the deflections of the supports or equivalent physical quantities are detected simultaneously at measuring points and the acceleration components contained in these measurement values are mathematically eliminated by first eliminating the acceleration forces in the longitudinal direction by way of pairwise mathematical combination of two sensors, and by thereafter eliminating the vertical acceleration through mathematical combination of the values obtained from these acceleration pairs, so that the gravitational acceleration remains as an isolated quantity, from which the vertical acceleration and then the longitudinal acceleration can be recovered.

In another preferred method for determining a movement having static and dynamic acceleration components, four sensors with mass elements are provided, which are each arranged on at least one base plate with a corresponding elastic support and which can be deflected by acceleration forces in one plane or in parallel planes oriented perpendicular to the base plate, wherein the supports have identical dynamic or static response characteristics for one of the acceleration forms and have a different response characteristic for the other acceleration form, wherein in each case two supports are identical but arranged with mirror symmetry, and wherein the deflections of the supports or equivalent physical quantities can be measured at measurement points and computationally processed, with the following method steps:
the deflection, or another physical quantity of at least one measurement point of the respective sensors is measured simultaneously under acceleration conditions and the measured values are subjected to a mathematical elimination of acceleration components which includes at least,
the dynamic acceleration component oriented parallel to the base plate is eliminated by mathematically combining the measured deflection values or the equivalent physical quantities of the sensors forming a pair and of the mirror-symmetrically arranged sensors forming another pair,
the acceleration component acting vertically on the base plate is eliminated by a mathematical combination between the values of the sensor pairs adjusted for the dynamic acceleration component oriented parallel to the base plate,
and the so-determined angle (α) of the base plate relative to the horizontal is used for determining the parallel acceleration (PB) relative to the base plate and the vertical acceleration (VB) relative to the base plate.

Another preferred method for determining a movement having static and dynamic acceleration components employs for two sensors with mass elements, which are arranged on a base plate and each have an elastic support, and which can be deflected by acceleration forces in one plane or in parallel planes arranged perpendicular to the base plate, wherein the supports have identical dynamic or static response characteristics for one of the acceleration forms and have a different response characteristic for the other acceleration form, with the following method steps:
the deflection, or another physical quantity of at least one measurement point of the sensors is simultaneously measured under acceleration conditions when the vertical acceleration is negligible, and the measured values are subjected to a mathematical elimination of acceleration components, which includes at least
the dynamic acceleration component oriented parallel to the base plate is compensated by a mathematical combination of the measured deflection values or of the equivalent physical quantities of the sensors,
and the so-determined angle (α) of the base plate relative to the horizontal is used for determining of the parallel acceleration (PB) with respect to the base plate.

In another preferred method for the determining a general movement having static and dynamic acceleration components with at least three sensors (with negligible vertical acceleration also with at least two sensors) each having mass elements, which are arranged on at least one base plate and each have an elastic support and which can be deflected by acceleration forces in a plane or in planes which are arranged perpendicular to the base plate, wherein the supports have identical dynamic or static response characteristics for one of the acceleration forms and have a different response characteristic for the other acceleration form, the deflections of the supports or equivalent physical quantities are detected simultaneously at the measuring points and a mathematical elimination of acceleration components contained in these measurement values is performed by first eliminating the acceleration forces in the longitudinal direction by pairwise combination of two sensors, and by thereafter eliminating the vertical acceleration by combining the values obtained from these acceleration pairs, so that the gravitational acceleration remains as an isolated quantity, from which the vertical acceleration and thereafter the longitudinal acceleration can be recovered.

The second elimination is omitted when the vertical acceleration is negligible.

Recovery of the vertical and the longitudinal acceleration must produce the same result for all sensors when the accelerations are oriented parallel and perpendicular to the base plate. When this is not the case, an iterative approach (self-calibration) can be performed using testing algorithms. In other words, the system has a self-correcting mechanism for the correct arrangement of the sensors and the normalization of their response to the type of acceleration, preferably the longitudinal acceleration.

Such a device, which is suitable for the separate detection of a static and a dynamic acceleration, can be used in the invention to determine at least one position parameter of at least parts of the device in space. These position parameters may be location and/or orientation values in two or three dimensions.

According to a preferred embodiment of the invention, for determining the at least one position parameter, static and dynamic acceleration may be separated, and especially the gravitational acceleration and movement acceleration may be separated across all quadrants.

In a preferred embodiment of a use according to the invention, determining the position includes determining a component of the acceleration due to gravity. The gravitational acceleration is thus separated from the total acceleration measured by the device. That has proven to be particularly advantageous, because a movement of the device relative to a reference coordinate system, in particular with respect to the horizontal or vertical, can then be detected.

In a preferred embodiment, the use includes control of processes. This is particularly advantageous for controlling computer-based applications, such as computer games.

Preferably, the use includes an analysis of general movements of bodies. In a preferred embodiment, depending on the result of the analysis, a particular function is associated with the movement and/or technical means can be controlled in order to perform with the technical means a desired movement. Preferably, the movement is performed with a control loop.

Particularly advantageous is the use of the device for detecting and analyzing movements in sports activities. The device can be integrated into sporting equipment and/or in sportswear. Another advantageous use is the analysis of movements for training purposes.

Another advantageous use of the device is in the field of surveillance of persons. In this particular use, daily profiles of a person about their fundamental states, such as activities, rest/activity phases, movements underlying a fundamental state, and the like, may be created

In a preferred use, changes in position of an object may be detected, referring to changes in the position and/or the orientation of the object. This proves to be particularly advantageous for the detection of movements of transported objects relative to the movement of the transport means. In particular, a shift or inclination of a transported object relative to the transport means can be detected.

Another preferred use relates to the detection of an inclination of an object. This is particularly advantageous when monitoring dynamically supported objects. Such a dynamically supported objects may be, for example, terrestrial, air-borne or marine vehicles, wherein their movement has superimposed thereon air or water movements, so that changes in the inclination occur in addition to the movement acceleration.

According to another preferred use, the position (position and/or orientation) of an object can be stabilized. This is advantageous in particular for stabilizing aircrafts.

In another preferred use, a writing movement may be analyzed.

In general, the device may also be used to record and/or to document the separate static and dynamic acceleration components of movements as well as to reconstruct movements. In particular, a reconstruction of the movement associated only with the static acceleration component or only with the dynamic acceleration component may be advantageous.

According to a first aspect of the invention, a computer program enables a data processing device, after the computer program has been loaded into memory means of the data processing device to perform a method for detecting at least one acceleration, wherein a device is used which includes at least one base plate and at least two mass elements, wherein each mass element is connected via an elastic support element with the at least one base plate, wherein the support elements can be deflected in a common plane or in parallel planes, and wherein the at least two mass elements and/or support elements each have at least one measuring point, and wherein the support elements of at least one first and at least one second mass element are constructed such that the support element of the at least one first mass element and the support element of the at least one second mass element have at the measuring points an identical response characteristic for a first component, acting in a first direction, of an acceleration acting in the common plane or in the parallel planes, and mutually different response characteristics for a second component of the acceleration acting perpendicular to the first component, and wherein data describing the deflection of the measuring points are obtained for at least one first and at least one second mass element and/or support element, wherein the component of the acceleration acting in the first direction is eliminated by evaluating the detected data, and wherein, when the component acting in the second direction is negligible, the result adjusted for the component acting in the first direction is used for recovering the component acting in the first direction, and the result adjusted for the component acting in the first direction is measured as static acceleration and the component acting in the first direction is measured as dynamic acceleration.

A computer program according to a second aspect of the invention enables a data processing device, after the computer program has been loaded into memory means of the data processing device to perform a method for detecting at least one acceleration, wherein a device is used which includes at least one base plate and at least three mass elements, wherein each mass element is connected via an elastic support element with the at least one base plate, wherein the support elements can be deflected in a common plane or in mutually parallel planes, and wherein the at least three mass elements and/or support elements each have at least one measuring point, and wherein the support elements of at least two first and at least one second mass element (6) are constructed such that the support elements of the at least two first mass elements and the support element of the at least one second mass element have at the measuring points an identical response characteristic for a first component, acting in a first direction, of an acceleration acting in the common plane or in the parallel planes, and have mutually different response characteristics for a second component of the acceleration acting perpendicular to the first component, and wherein data describing the deflection of the measuring points are obtained for at least one first and at least one second mass element and/or support element, wherein the component of the acceleration acting in the first direction is each eliminated by evaluating the data collected from the mass elements of a first of the at least two first mass/support elements and the second mass element and/or support element, and by evaluating the data collected from the mass elements of a second of the at least two first mass/support elements and the second mass element and/or support element, and wherein the component acting in the second direction is eliminated by evaluating the two results adjusted for the component acting in the first direction, and wherein the result adjusted for the component acting in the second direction is used to recover the components acting in the first and second direction, and wherein the result adjusted for the components acting in the first and second directions is measured as static acceleration and the components acting in the first and second directions are measured as dynamic acceleration.

A computer program according to a third aspect of the invention configures a device suitable for the separate detection of a static and a dynamic acceleration, after the computer program has been loaded into memory means of the device, so that the device is available for use in analyzing movements, wherein at least one position parameter of at least parts of the device is determined in space.

In another preferred embodiment of the invention, the inventive computer program may have a modular construction, wherein individual modules are installed on different parts of the data processing device.

Preferred embodiments also contemplate computer programs with which additional method steps or process flows described in the description can be executed.

Such computer programs can be provided, for example, (fee-based or free of charge, freely accessible or password-protected) for downloading in a data or communication network. The provided computer programs may also be used with a process wherein a computer program according to claim 9 is downloaded from an electronic data network, for example from the Internet, to a data processing system connected to the data network.

To perform the method of the invention, a computer-readable storage medium may be used on which a program is stored, which enables a data processing device, after the program is loaded into memory means of the data processing device, to execute a method for measuring at least one acceleration, wherein a device is used, which includes at least one base plate and at least two mass elements, wherein each mass element is connected via an elastic support element with the at least one base plate, wherein the support elements can be deflected in a common plane or in parallel planes, and wherein the at least two mass elements and/or support elements each have at least one measuring point, and wherein the support elements of at least one first and at least one second mass element are constructed such that the support element of the at least one first mass element and the support element of the at least one second mass element have at the measuring points an identical response characteristic for a first component, acting in a first direction, of an acceleration acting in the common plane or in the parallel planes, and mutually different response characteristics for a second component of the acceleration acting perpendicular to the first component, and wherein data describing the deflection of the measuring points are obtained for at least one first and at least one second mass element and/or support element, wherein the component of the acceleration acting in the first direction is eliminated by evaluating the detected data, and wherein, when the component acting in the second direction is negligible, the result adjusted for the component acting in the first direction is used for recovering the component acting in the first direction, and the result adjusted for the component acting in the first direction is measured as static acceleration and the component acting in the first direction is measured as dynamic acceleration.

For performing an alternative variant of the method according to the invention, a computer-readable storage medium may be employed on which a program is stored, which enables a data processing device, after the program is loaded in memory means of the data processing device, to execute a method for measuring at least one acceleration, wherein a device is used, which includes at least one base plate and at least three mass elements, wherein each mass element is connected via an elastic support element with the at least one base plate, wherein the support elements can be deflected in a common plane or in parallel planes, and wherein the at least three mass elements and/or support elements each have at least one measuring point, and wherein the support elements of at least two first mass elements and at least one second mass element are constructed such that the support elements of the at least two first mass elements and the support element of the at least one second mass element at the measuring points have an identical response characteristic with respect a first component, acting in a first direction, of an acceleration acting in the common plane or in the parallel planes, and have mutually different response characteristics for a second component of the acceleration acting perpendicular to the first component, and wherein data describing the deflection of the measuring points are obtained for at least one first and at least one second mass element and/or support element, wherein the component of the acceleration acting in the first direction is each eliminated by evaluating the data collected from the mass elements of a first of the at least two first mass/support elements and the second mass element and/or support element and by evaluating the data collected from the mass elements of a second of the at least two first support elements and the second mass element and/or support element, and by evaluation of the two results adjusted for the component acting in the first direction, the component acting in the second direction is eliminated, and wherein the result adjusted for the component acting in the second direction is used to recover the components acting in the first and second direction, and wherein the result adjusted for the components acting in the first and second directions is measured as static acceleration and the components acting in the first and second directions are measured as dynamic acceleration.

To allow the use of the invention, a computer-readable storage medium may be employed on which a program is stored, which configures a device suitable for separate detection of a static and a dynamic acceleration, after the computer program has been loaded into memory means of the device, so that the device is can be used for analyzing movements, wherein at least one position parameter of at least parts of the device is determined in space.

Uses according to the invention will now be described in greater detail with reference to various exemplary embodiments. The embodiments relating to the use according to the invention are preceded by a description of an exemplary device for a separate detection of a static and a dynamic acceleration and a corresponding evaluation method.

It is shown in:

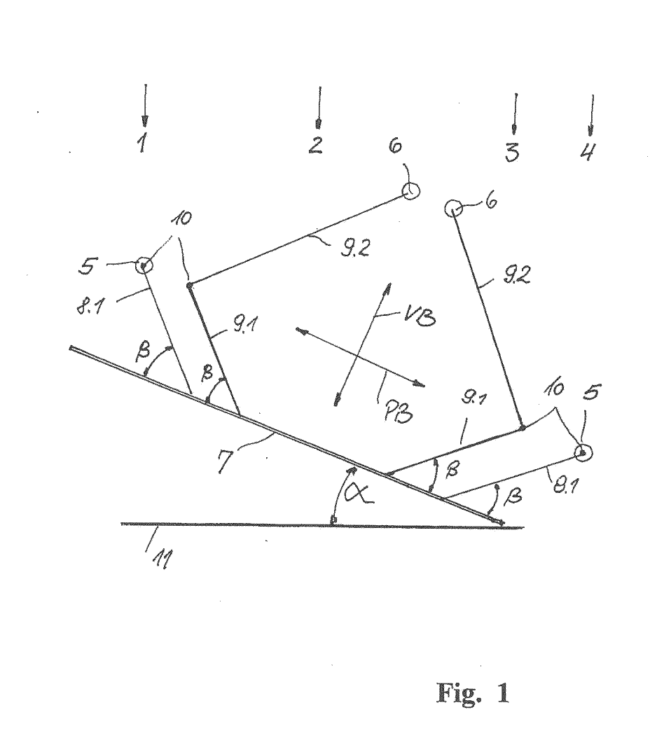

FIG. 1 a sensor block of 4 sensors in a sensor plane,

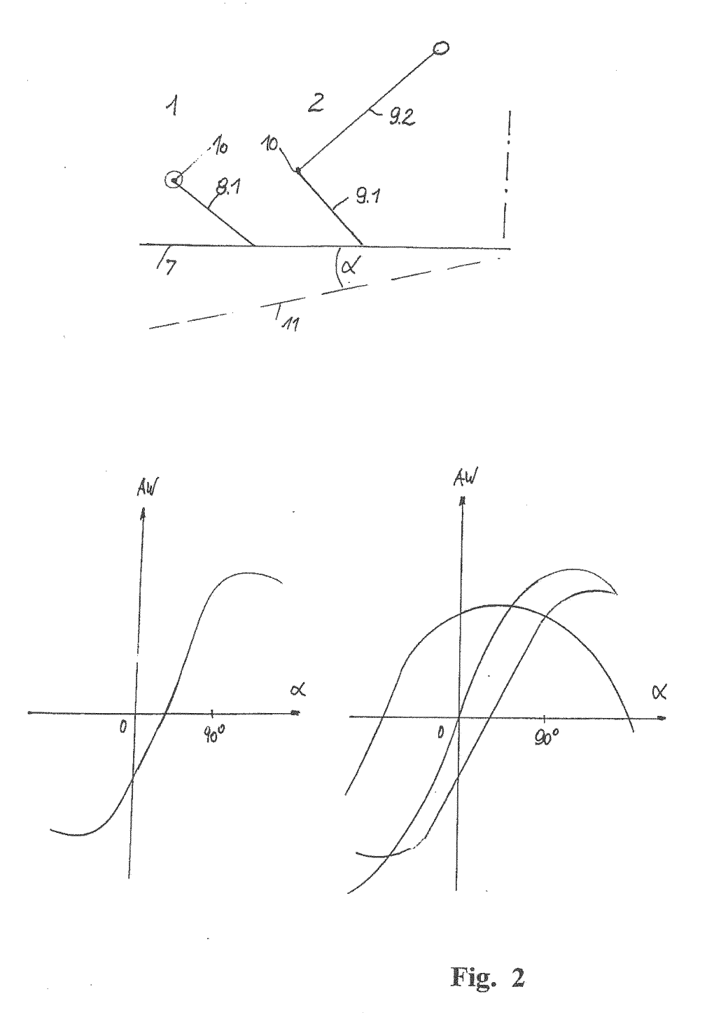

FIG. 2 the characteristic curves for accelerations,

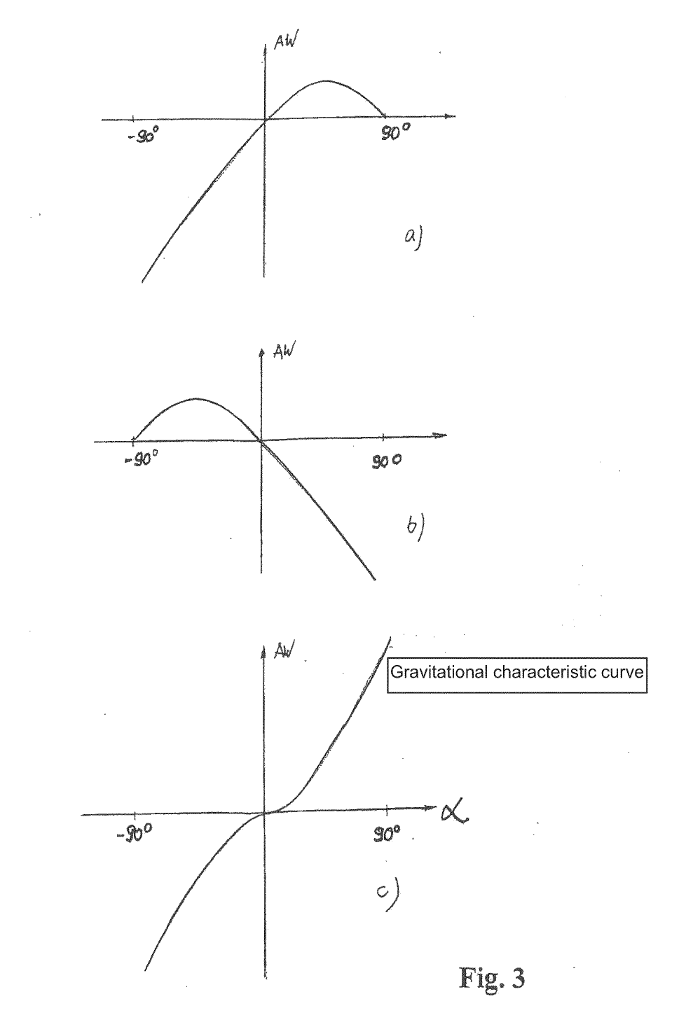

FIG. 3 the mathematical elimination of acceleration components with four sensors,

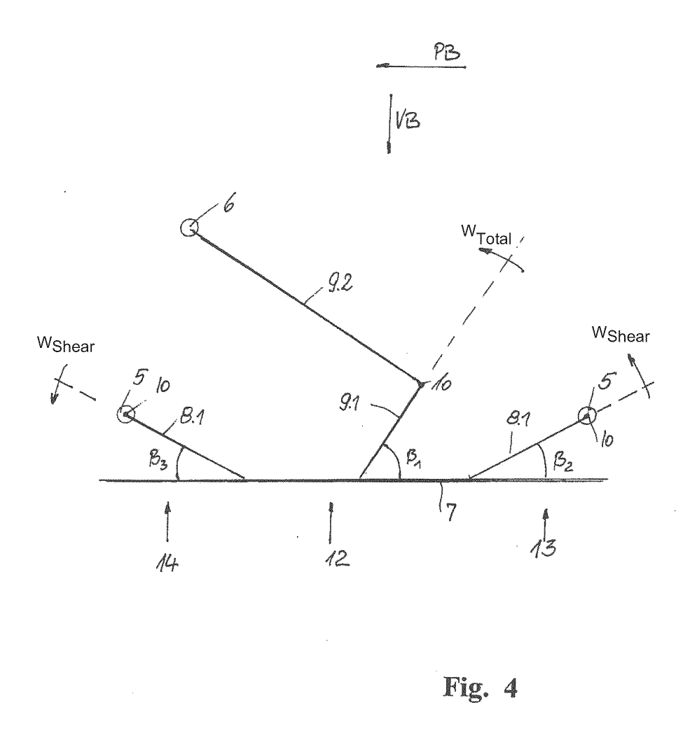

FIG. 4 a sensor block of three sensors,

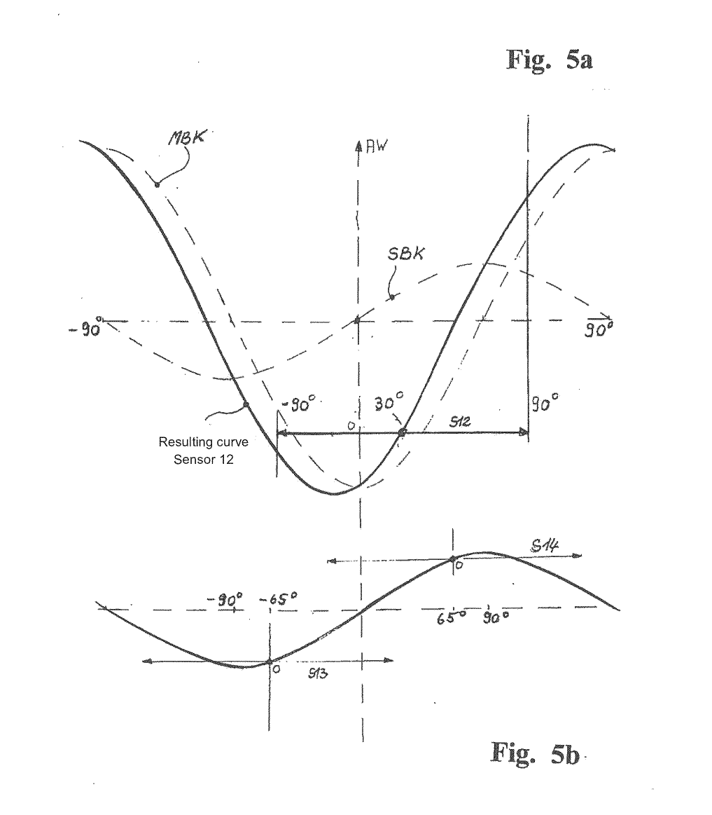

FIG. 5 the characteristic curves for accelerations,

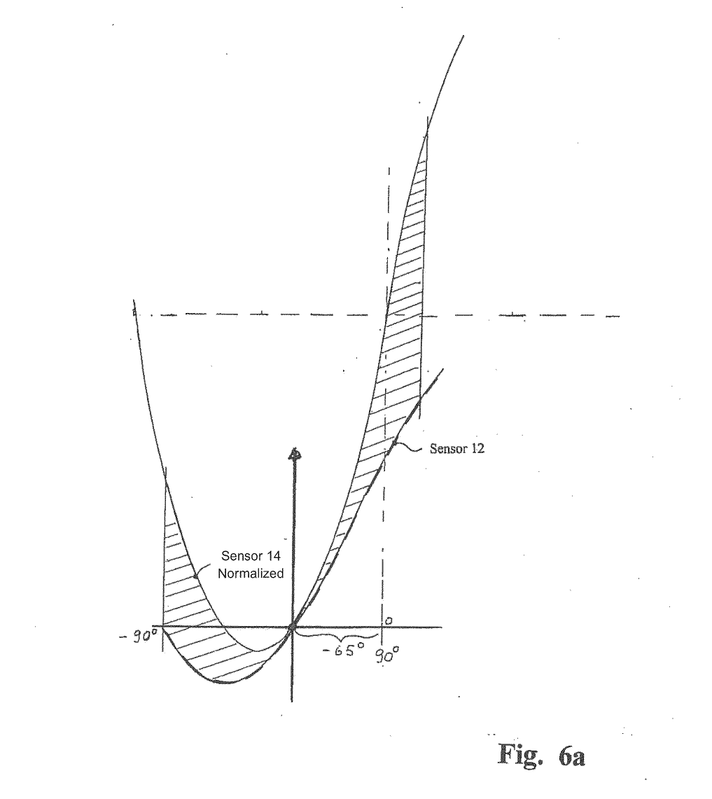

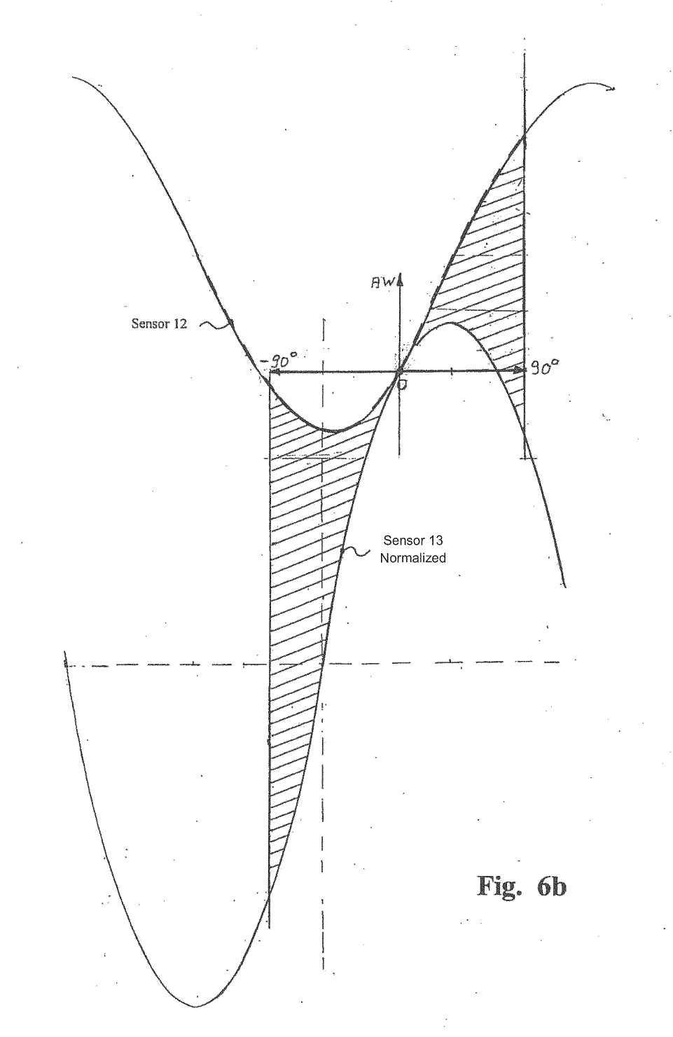

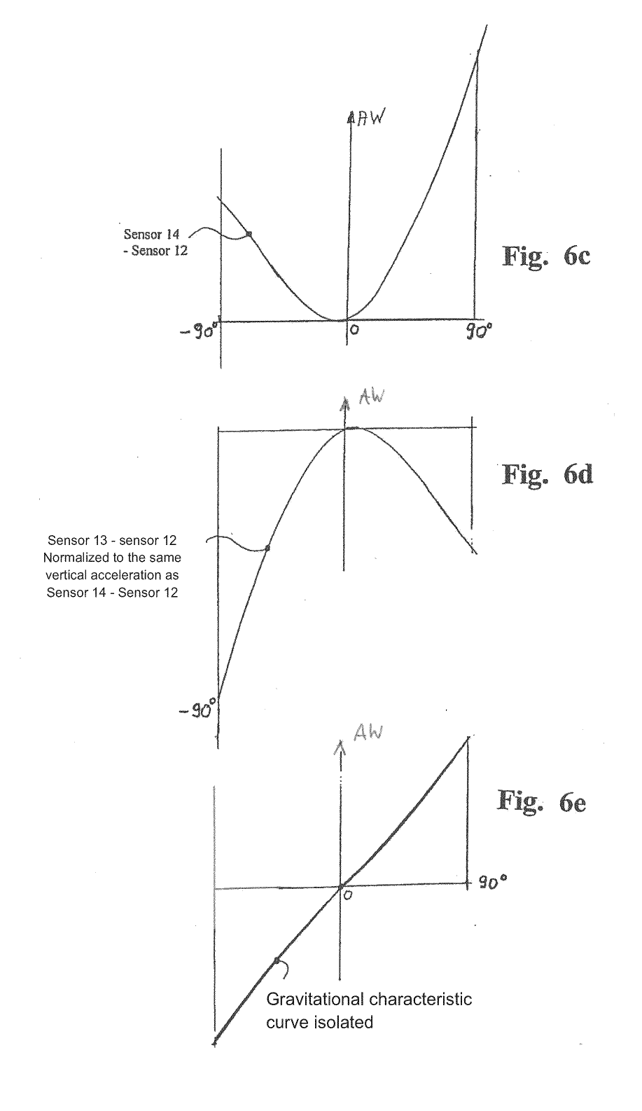

FIG. 6 the mathematical elimination of acceleration components with three sensors, and

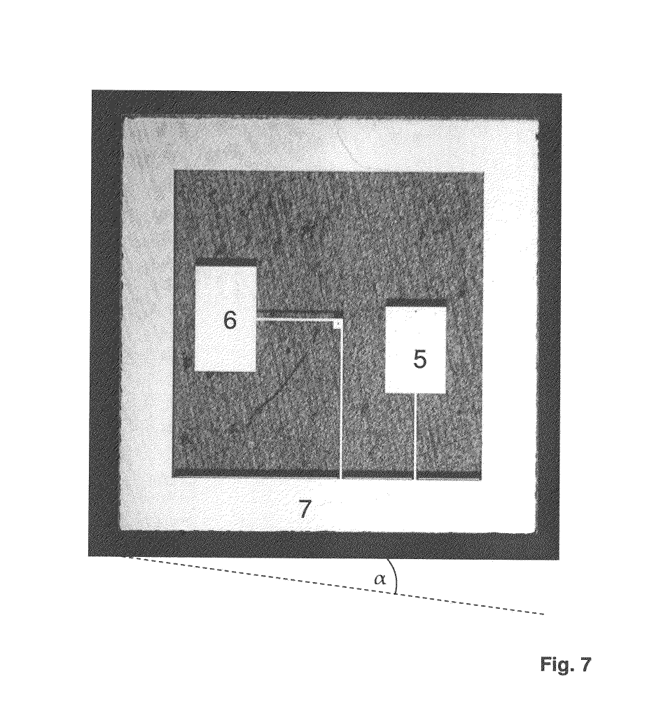

FIG. 7 an embodiment in silicon.

FIG. 1 shows a mechanical embodiment of the device for determining a movement having static and dynamic acceleration components on a base plate 7 inclined relative to the horizontal 11 by the angle (α) and having four sensors 1-4.

The following acceleration quantities can be determined with the sensors 1-4 of the sensor block
the angle (α) representing the inclination of the sensor unit, or more accurately, of the base 7 relative to the horizontal 11,
the parallel acceleration (PB) relative to the base 7, also referred to as longitudinal acceleration, and
the vertical acceleration (VB) relative to the base plate 7.

Each of the four sensors 1-4 has a mass element 5 or 6, which are each arranged on the base plate 7 with a respective elastic support 8, 9 and which can be deflected by the acceleration forces in a plane, the sensor plane, oriented perpendicular to the base plate 7. Each two supports are identical, but arranged mirror-symmetrically.

The supports 8, 9 of the mass elements 5, 6 play a key role for the universal operation of the proposed device. These supports 8, 9 of the sensors 1, 2 and 3, 4, which each form a pair, must satisfy the condition to have an identical dynamic or static response characteristic for one of the acceleration forms and a different response characteristic for the other acceleration form.

The illustrated embodiments of the sensor pairs 1, 2 and 3, 4 satisfy this condition, because the support 8 is a rod 8.1 or a strip 8.1, wherein for example a strip 8.1 can be elastically deformed in the plane of the strip. The support 9 is formed by an angled or bent rod or strip having the sections 9.1, 9.2.

Since the evaluation method is based on a mathematical elimination of acceleration components, for example by forming a difference between the simultaneously measured values of the deflection or of another equivalent physical quantity of the measuring points 10 caused by the acceleration, it is advantageous to provide, whenever possible, structural equivalence and an optimized design.

In advantageous embodiments, the shape and deformability of the section 9.1 of the rod or strip of the support 9 therefore corresponds in the initial region, as seen from the base plate 7, to that of the respective rod or strip 8.1.

This also means that the angled section 9.2 encloses an angle of 90° with the section 9.1. Advantageously, the two sections 9.1, 9.2 may have different lengths; preferably, the section 9.2 is longer than the section 9.1.

The principle of the method according to the invention will now be explained with reference to FIG. 2 and FIG. 3.

FIG. 2 shows half a sensor block with the characteristic curves of the response characteristics of the sensors 1 and 2, wherein the characteristic curves of the sensors 3 and 4 are constructed mirror-symmetrically, which obviates the need for a separate illustration.

The sensors 1 and 2 are shown at the top, and underneath the respective characteristic curves due to gravitational acceleration for the output signal (AW), which is measured at the measuring point 10 and is thereafter processed by mathematically eliminating acceleration components.

The supports 8, 9 of the sensors 1, 2 and 3, 4, which each form a respective pair, must satisfy the condition to exhibit identical dynamic or static response characteristics for one of the acceleration forms and a different response characteristic for the other acceleration form.

This is achieved with the sensor pairs in that the support 8 is formed by a rod 8.1 and the support 9 is formed by an angled rod with the sections 9.1, 9.2.

The sensors have the following characteristic curves profiles:

The characteristic curve for static acceleration, i.e. for different angle positions of the sensor block relative to the horizontal plane, is defined for the sensor 1 and 4, respectively, by the change in the gravitational force perpendicular to the rod plane. The result is the characteristic curve shown on the left in FIG. 2. With an angled sensor 2 and 3, respectively, another component is superimposed on the characteristic curve of sensor 1 and 4, which arises from the angled section acting as a lever 9.2. This is illustrated by the characteristic curve shown on the right in FIG. 2. A more detailed explanation is given further below in the discussion of FIGS. 5 and 6.

In the method for determining a movement having static and dynamic acceleration components using this arrangement with four sensors 1-4 having mass elements 5, 6, which are each arranged on at least one base plate 7 with a respective elastic support 8, 9 and which can be deflected by acceleration forces in one plane or in parallel planes oriented perpendicular to the base plate 7, wherein the plane(s) enclose with all base plates 7 a 90° angle, and wherein the supports 8, 9 have an identical dynamic or static response characteristic for one of the acceleration forms and have different response characteristics for the other acceleration form, wherein two corresponding supports are each identical but arranged mirror-symmetrically, and wherein the deflections of the supports or equivalent physical quantities can be measured at measurement points 10 and computationally processed, the deflection or another physical parameter of at least one measurement point 10 of the respective sensors 1-4 is simultaneously measured under acceleration conditions and the measured values are subjected to a mathematical elimination—here a difference formation, which includes at least:

### 1. Difference Formation

The dynamic acceleration component which is oriented parallel to the base plate 7 (longitudinal acceleration) is compensated by forming a difference of the measured deflection values or the equivalent physical quantities of the sensors 1 and 2 as one pair, and of the mirror-symmetrically arranged sensors 3 and 4 as another pair.

The prerequisite is here that the sensors 1 to 4 are each normalized to have the same response to the longitudinal acceleration. Prerequisite for obtaining meaningful computational results is further that the gravitational characteristic curves of the sensors 1 to 4 have different characteristic curve profiles in the two quadrants. The greater the deviation is, the less is the effect caused by manufacturing tolerances, measurement errors in the measurement of the displacement, etc.

The sensors 1 and 2 of the first sensor pair shown in FIG. 2 satisfy these conditions. The selected angle β is about 30° and the length of the arms 9.2 corresponds to approximately three times the length of the arm 9.1 and the rod support 8.1.

While the longitudinal acceleration acts on the sensor 1 only in the form of a shear bending, shear bending and bending moment overlap in sensor 2.

To obtain in the sensor output signal for sensor 1 the same reaction, i.e. deflection, in response to longitudinal acceleration as for sensor 2, the output signal must be amplified by a predetermined factor.

With this in mind, the gravitational characteristic curves are shown in FIG. 2, at the left for sensor 1 and at the right for sensor 2. The longitudinal acceleration is eliminated when forming the first difference between these characteristic curves, since the same reaction of the two sensors 1 and 2 in response to longitudinal acceleration at the measuring point 10 was assumed.

FIG. 3a and FIG. 3b show the course of the difference between the gravitational curves of the sensors after forming the first difference.

The upper curve (FIG. 3a) corresponds to the difference formed between the sensors 1 and 2 and the center curve (FIG. 3b) to the difference formed between the sensors 3, 4.

### 2. Difference Formation

The dynamic acceleration component acting vertically to the base plate 7 is compensated by forming the difference between the values of the sensor pairs 1, 2 and 3, 4 adjusted for the dynamic acceleration component oriented parallel to the base plate 7, in the simplest case also by subtraction or, where necessary, by adjusting the levels of the measured values before forming the difference, in order to eliminate the component of the vertical dynamic acceleration in the measured value.

With the employed identical, but mirror-symmetrically arranged sensor pair 3, 4, whose output signals are processed in the same manner as the signals of the sensor pair 1, 2 when forming the first difference, the vertical acceleration component can be determined by subtraction, since the same acceleration force acts on each sensor, thus producing the same vertical acceleration components in the difference curves after forming the first difference.

With forming a difference between the pairs 1, 2 and 3, 4, the vertical dynamic accelerations relative to the base plate 7, as shown in FIGS. 3a and 3b, cancel each other.

The aforementioned difference formations include as part of the measured values of the individual sensors 1-4 also the components of the static acceleration as a yet unknown quantity. After the aforedescribed eliminations, this value remains as a difference value, with which a certain angle (α) can be associated. The complete characteristic curve profile of the difference values is shown in FIG. 3c.

This subtraction produces the result that, due to the asymmetry of the gravitational characteristic curves in the two quadrants, the gravitational values (α) are negative in one quadrant and positive in the other quadrant, i.e. there is in both quadrants an unambiguous association between the sensor output signals and the angle value.

The thus determined angle (α) of the base plate 7 with respect to the horizontal 11 is used to determine the parallel acceleration (PB) relative to the base plate 7 and the vertical acceleration (VB) relative to the base plate 7.

When a movement having static and dynamic acceleration components is to be determined, wherein the vertical acceleration is negligible and only one quadrant is of interest, only two sensors 1, 2 are required, wherein the sensors 1, 2 are arranged as previously described and the supports 8, 9 have identical static and dynamic response characteristics for one of the acceleration forms and a different response characteristics for the other acceleration form.

The deflection or another physical quantity of at least one measurement point 10 of the sensors 1, 2 is measured simultaneously under acceleration conditions where the vertical acceleration is negligible, and the measured values are subjected to a difference formation which includes at least:

The dynamic acceleration component oriented parallel to the base plate 7 is compensated by a difference formation, in the simplest case, a subtraction of the measured deflection values or the equivalent physical quantities of the sensors 1 and 2.

This obviates the need to form the difference for eliminating the vertical acceleration, because a prerequisite for this movement was that the vertical acceleration can be neglected.

The component of the static acceleration as a yet unknown quantity is here also included in the aforementioned difference formation as part of the measured values of the individual sensors 1-2. Following the aforementioned eliminations, this value remains as difference value, with which a certain angle (α) can be associated.

The thus determined angle (α) of the base plate 7 with respect to the horizontal 11 is used to determine the parallel acceleration (PB) relative to the base plate 7, which is done computationally.

FIG. 4 shows a sensor block with three sensors 12-14 as an advantageous embodiment of the above version with four sensors 1-4.

The sensor 12 in this arrangement assumes a dual function. It is, on one hand, part of the sensor pair 12, 13 and, on the other hand, part of the sensor pair 12, 14.

In order to be able to carry out the aforementioned principle of step-wise elimination of acceleration components that are part of a measured value, a special arrangement of the supports 8, 9 has been implemented in an advantageous embodiment.

However, it is specifically noted that this special design does not limit the system. Rather, other length ratios and angles are also feasible.

A value of 25° was selected for the angle β₂ between the support 8.1 and the base plate 7 of the sensor 13. The support 8.1 of the sensor 14 is arranged mirror-symmetrically thereto and inclined relative to the base plate 7 by the angle β₃=−25°. The inclination of the support 9.1 of the sensor 12 has an inclination angle to the base plate 7 of β₁, here 60°.

The lengths of the rod supports 8.1 of sensors 13 and 14 are identical to the length of the section 9.1 of the sensor 12, while the length 9.2 of the sensor 12 corresponds to three times the length of the section 9.1.

To obtain in the sensor output signal for the sensor 13 and 14, respectively, the same response, i.e. the same deflection in response to longitudinal acceleration, as for the sensor 12, amplification of the output signal by a predetermined scaling factor is necessary.

In the illustrated embodiment, this scaling factor is calculated, for example, to be 5.6 for the longitudinal acceleration, taking into account for sensor 12 the shear bending and bending moment, whereas the longitudinal acceleration acts on the sensors 13 and 14 only in the form of a shear bending and is moreover identical.

FIG. 5 shows exemplary gravitational characteristic curves for a sensor block with the sensors 12 to 14 illustrated in FIG. 4.

The gravitational characteristic curve for elastically supported masses has a sinusoidal profile, as is illustrated in FIGS. 5a and 5b.

In a certain initial angular position, here for the sensors 13 and 14 with the inclination angles β₁ and β₂ relative to the base plate, the operating point on the characteristic curve is shifted by the corresponding angle of 90°−β₁, here 65°, and −(90°−β₂), here −65°, respectively, relative to the reference coordinates with β=90°. The workspaces of the sensors 13 and 14 are indicated with S13 and S14. The same applies to sensor 12 with the workspace S12.

In FIG. 5a shows the resulting characteristic curve of the sensor 12 under the influence of gravity.

This characteristic curve is composed of the characteristic curve profiles of the bending moment component (MBK) and the shear bending component (SBK).

FIG. 5b shows the non-normalized characteristic curve profile of the sensors 13 and 14 under the influence of gravity.

FIG. 6 shows the stepwise mathematical elimination of the individual acceleration components.

To obtain in the sensor output signal for the sensor 13 and 14, respectively, the same response, i.e. the same deflection in response to longitudinal acceleration, as for the sensor 12, the output signal must be amplified with the aforementioned scaling factor. Only then is the longitudinal acceleration component eliminated by the first difference formation between the measured deflection values (output signals AW).

FIG. 6a shows for the same workspaces the gravitational characteristic curve of the sensor 12 and the normalized characteristic curve of the sensor 14 formed by multiplication with the scaling factor.

FIG. 6b shows for the same workspaces the gravitational characteristic curve of the sensor 12 and the normalized characteristic curve of the sensor 13 formed by multiplication with the scaling factor.

The diagrams also reveal that the prerequisite for obtaining meaningful computational results is fulfilled, namely that the gravitational characteristic curves of the sensors have mutually different characteristic curve profiles in the two quadrants.

When, as provided by the method, the respective characteristic curve profiles in FIGS. 6a and 6b are subtracted from each other in the first difference formation, which corresponds to the content of the respective hatched areas, the resultant intermediate characteristic curves shown in FIGS. 6c and 6d are obtained. FIG. 6c shows the characteristic curve resulting from the difference formation of sensor 14 and sensor 12, and FIG. 6d shows the characteristic curve resulting from the difference formation of the sensors 13 and 12. The diagram in FIG. 6d is here already normalized to the same vertical acceleration as the characteristic curve in FIG. 6c, so that the vertical acceleration can actually be eliminated in the second difference formation.

Since with a vertical acceleration the deflections of the sensor 14 and sensor 12 occur in the same direction, their absolute difference is smaller compared to the absolute difference of sensor 13 and sensor 12, where the deflections are in opposite directions, so that the difference signal from sensor 14 and 12 must be increased or the difference signal from sensor 13 and sensor 12 must be decreased in order to attain the same level.

With this normalization, the levels of the differential characteristic curves are also matched. Because due to the normalization factors for the same longitudinal acceleration, the sensor 14 and sensor 13 have a greater response to vertical accelerations than the sensor 12, the mathematical signs of the difference formation are defined by these sensors. The difference between the sensor 14 and sensor 12 is thus negative, and the difference between sensor 13 and sensor 12 positive, meaning that the values must be added in the second difference formation for eliminating the vertical acceleration.

FIG. 6e shows the result of the second difference formation, so that a specific angle (α) is to be associated with a measured sensor output signal.

The thus determined angle (α) of the base plate 7 relative to the horizontal 11 is used to determine the vertical acceleration (VB) and the parallel acceleration (PB) relative to the base plate 7, which is done computationally.

In the sensor arrangement illustrated in FIG. 4, the desired gravitational characteristic curve can thus also be obtained by mathematical combination, wherein minor level adjustments to eliminate the longitudinal as well as the vertical acceleration do not affect the gravitational characteristic curve.

FIG. 7 shows a first exemplary embodiment for a micromechanical assembly with 2 sensors. The arrangement of the sensors 1, 2 is formed in a substrate as a three-dimensional microstructure, with mass elements 5, 6 and elastic supports 8, 9, wherein the substrate is preferably single-crystalline silicon (Si) or quartz or glass, or a varnish.

In the micro-mechanical embodiment, the support 8 of the mass 5 is likewise a rod 8.1 or a strip 8.1, wherein the strip 8.1 is elastically deformable in the strip plane. The support 9 of the mass 6 is formed by an angled or bent rod or strip with the sections 9.1 and 9.2.

This applies likewise to an arrangement with three or four sensors, as described above. Reference is therefore made only to sensors from here on.

In an advantageous embodiment, the three-dimensional microstructure of the sensors is formed in a well of the substrate, wherein the well walls form a base plate 7.

Likewise, the three-dimensional microstructure of the sensors can be arranged in a common frame of the substrate, or in a separate frame for each sensor or sensors, wherein one or two parallel sides of the frame form in each case the base plate 7.

Furthermore, the three-dimensional microstructure of the sensors may be encapsulated, preferably configured for evacuation. This advantageously eliminates friction caused by gas which may distort the measurement results.

In a further advantageous embodiment, the electronics for evaluating the measurement results may be integrated in the substrate in addition to the sensors.

The three-dimensional microstructure can be produced by conventional processes, such as bulk micromachining, the LIGA technique, embossing or electro-erosion, without limiting the invention to these processes.

Preferably, optical detection of reference points, capacitive evaluation for example by measuring the distance between supports and fixed points, and resistive evaluation techniques using piezoelectric technology or strain gauges are used for the measurements.

With the proposed sensor technology, movements having very general types of static and dynamic acceleration components can be analyzed without neglecting individual acceleration components. Due to the cost-effective micromechanical sensor technology, its use is not limited. This will lead to new quality standards not only in industry but also as mass-produced consumer goods.

Advantageous applications of the sensors or sensors blocks are especially seen
in an analysis of general movements of bodies. These include in particular tachograph functions, the analysis of movements in sports like swimming, throwing, pushing; in skiing the analysis of the ski movement and the athlete; in boxing the analysis of punches, as well as general evaluations of body conditions.
in an analysis of movements for associating a particular function with the movement. For example, connection and disconnection processes may be initiated, as well as other more complex manual functional sequences and/or other body movements. This includes reading of sign language and the handwriting recognition when writing.
in an analysis of the movement for performing a deliberate movement by technical means in a control loop. Particularly machine and vehicle controls are here of particular importance, but also prosthetic movements and control circuits to maintain body functions.

In an exemplary use of the device suitable for the separate detection of a static and a dynamic acceleration (hereinafter also called dynamics recorder), the device may be used as a tachograph or an accident data recorder. Particularly advantageous is the use for terrestrial, marine and air-borne vehicles. The movements of these vehicles are significantly affected by dynamic processes. Changes in the inclination occur in these vehicles in addition to the movement acceleration due to slopes, air or water movement. Separation of the acceleration forms is required for recording and reconstructing the movements. For example, accidents can be reconstructed by recording the dynamic values.

Another field of use of the device relates to the detection of movement of goods in transit. The separation of static and dynamic acceleration is hereby required in order to detect inclined positions, slippage of loads and other positional changes, in order to initiate a signal, if necessary.

Another exemplary use contemplates measuring the movement of machines and/or construction vehicles. Separation of the acceleration forms is essential for controlling and operating cranes, excavators and other construction equipment, since for example changes in the position of devices and loads may result from the terrain and from wind and soil effects.

Another exemplary use of the dynamics recorder is in navigation, in particular for measuring and stabilizing the position of a vehicle. The separation of the acceleration forms is a prerequisite for measuring and stabilizing a position in any type of aircraft ranging from large aircraft to drones or model airplanes.

Another exemplary use relates to separate measurements of position angles relative to the horizontal plane and movement of the robotic arms, which is essential for any kind of robotic activity.

In another important embodiment, the dynamics recorder may be used in sports activities. Almost every movement in sports includes static and dynamic acceleration components. In one exemplary embodiment, at least one dynamics recorder may be incorporated in garments, sporting equipment or combined therewith for measuring and detecting these acceleration components. For example, the dynamics recorder may be integrated, example, in athletic shoes, tennis rackets, golf clubs and/or hockey sticks, in skis, in boxing gloves, etc. The obtained recordings could be used for training purposes, for reporting purposes, for testing and for documenting personal performance.

Another example of a use of the device suitable for separate measurement of static and dynamic acceleration is detection of movement on a person. In analogy to the movements in the field of sports, both acceleration forms occur, for example, also when moving the wrist. From an analysis of these movements, conclusions about the causes of movement can be derived, from which a type of daily profile with the fundamental states of the person (lying down, sitting, standing, walking, running, sport activities), potentially with more specificity regarding the activities and the underlying movements (such as driving a car) can be created. For this purpose, a dynamics recorder may be integrated, for example, in a watch.

Another example of a use of a dynamics recorder is an analysis of writing movements. For example, handwriting could be converted into block letters by analyzing writing movements. Since writing movements include static and dynamic acceleration components, only an acceleration sensor capable of separating the two effective quantities can be used even for this type of application. A dynamics recorder may be integrated, for example, in the front region of a ball pen.

In another important embodiment, the use of dynamics recorder is contemplated in the computer gaming industry. Even for computer games, where movements of people largely determine the game, player movements can be realistically included in the game by separating static and dynamic acceleration of the movement of a player, thus enabling entirely new games.

### REFERENCE LIST

1 Sensor
2 Sensor
3 Sensor
4 Sensor
5 Mass element
6 Mass element
7 Base plate
8 Support
8.1 Rod support
9 Support
9.1 Section of the support 9
9.2 Section of the support 9
10 Measuring point
11 Horizontal
12 Sensor
13 Sensor
14 Sensor
G Gravity
AW Output signal
PB acceleration oriented parallel to the base plate
VB acceleration oriented perpendicular to the base plate
MBK Bending moment component
SBK Shear bending component

1-38. (canceled)

39. A device for measuring at least one acceleration, comprising:
at least one base plate, and
at least two mass elements,
an elastic support element constructed for deflection in a common plane or in parallel planes and connecting a respective mass element with the at least one base plate, and
a corresponding measuring point disposed on the at least two mass elements or on the elastic support elements, or both,
wherein the elastic support elements of at least one first and at least one second mass element are constructed such that the elastic support element of the at least one first mass element and the elastic support element of the at least one second mass element have at the corresponding measuring points an identical response characteristic for a first component, acting in a first direction, of an acceleration acting in the common plane or in parallel planes and mutually different response characteristics for a second component of the acceleration acting in a second direction perpendicular to the first component.

40. The device of claim 39, wherein the device comprises at least two first elastic support elements having each a first mass element and at least one second elastic support element having a second mass element.

41. The device of claim 39, wherein the device comprises at least two first elastic support elements having each a first mass element and at least two second elastic support elements having each a second mass element.

42. The device of claim 39, further comprising a substrate having a three-dimensional microstructure forming an arrangement of the elastic support elements and the mass elements.

43. The device of claim 42, wherein the substrate is selected from single-crystal silicon, quartz, glass, and varnish.

44. The device of claim 39, comprising several base plates arranged in mutually parallel relationship, each base plate comprising the elastic support elements with mass elements to be included in a measurement.

45. The device of claim 39, wherein two elastic support elements with corresponding mass elements, which are arranged on the at least one base plate, are employed for measurements in a quadrant and when the component of the acceleration acting in the second direction is negligible.

46. The device of claim 39, wherein four elastic support elements with corresponding mass elements, which are arranged on the at least one base plate, are employed for general acceleration measurements in two quadrants in one plane or in parallel planes.

47. The device of claim 46, wherein the four elastic support elements are composed of pairs of elastic support elements of identical design, which are arranged mirror-symmetrically on the at least one base plate.

48. The device of claim 39, wherein a first elastic support element is constructed in a mechanical or micromechanical embodiment as a rod or a strip, wherein the strip is elastically deformable in a strip plane, and a second elastic support element is constructed as an angled or bent rod or as a strip having a first and a second section.

49. The device of claim 48, wherein a shape and a deformability of the first section of the rod or strip of the second elastic support element in an initial region, as seen from the base plate, correspond to that of the rod or strip of the first elastic support element.

50. The device of claim 48, wherein the first elastic support element and the first section enclose in the initial region of the second elastic support element an angle β<90° with the base plate.

51. The device of claim 48,
characterized in that
the second section encloses with the first section in the initial region of the second elastic support element an angle of 90°.

52. The device of claim 39, comprising at least three elastic support elements and connected mass elements arranged on the at least one base plate, wherein an angle β₂ between a first elastic support element and the base plate is oriented positively, whereas a second elastic support element is negatively inclined relative to the at least one base plate by the angle β₃, causing the second elastic support element to point in a different direction than the first elastic support element.

53. The device of claim 48, wherein the first section in the initial region of the second elastic support element is shorter than the second section.

54. The device of claim 42, wherein the three-dimensional microstructure is formed in a well of the substrate, and the at least one base plate is formed by well walls.

55. The device of claim 42, wherein the three-dimensional microstructure is arranged in a common frame of the substrate.

56. The device of claim 42, wherein the three-dimensional microstructure comprises separate frames for each of one or more elastic support elements having mass elements, wherein the at least one base plate is formed by parallel sides of a frame.

57. The device of claim 42, wherein the three-dimensional microstructure is constructed to be encapsulated or evacuated, or both.

58. The device of claim 39, further comprising electronics for evaluating the measurement results, wherein the electronics is integrated in the substrate in addition to the elastic support elements having mass elements.

59. The device of claim 39, wherein the elastic support elements having the mass elements are arranged in sensor blocks configured for measurement in one or several quadrants.

60. A method for detecting at least one acceleration using a device which comprises:
at least one base plate, and
at least two mass elements,
an elastic support element constructed for deflection in a common plane or in parallel planes and connecting a respective mass element with the at least one base plate, and
a corresponding measuring point disposed on the at least two mass elements or on the elastic support elements, or both,
wherein the elastic support elements of at least one first and at least one second mass element are constructed such that the elastic support element of the at least one first mass element and the elastic support element of the at least one second mass element have at the corresponding measuring points an identical response characteristic for a first component, acting in a first direction, of an acceleration acting in the common plane or in parallel planes and mutually different response characteristics for a second component of the acceleration acting in a second direction perpendicular to the first component,
the method comprising the steps of:
obtaining data describing a deflection of the measuring points for at least one first elastic support element having a mass element and at least one second elastic support element having a mass element,
eliminating the component of the acceleration acting in the first direction by evaluating the data, and
when the component acting in the second direction is negligible, recovering the component acting in the first direction by adjusting a result for the component acting in the first direction, and
measuring the result adjusted for the component acting in the first direction as static acceleration and measuring the component acting in the first direction as dynamic acceleration.

61. A method for detecting at least one acceleration using a device which comprises:
at least one base plate and
at least three mass elements,
wherein each mass element is connected via an elastic support element with the at least one base plate, wherein the elastic support elements can be deflected in a common plane or in parallel planes, and wherein the at least three mass elements or elastic support elements each have at least one measuring point, and wherein
the elastic support elements of at least two first mass elements and of at least one second mass element are constructed such that the elastic support elements of the at least two first mass elements and the elastic support element of the at least one second mass element have at the respective measuring points an identical response characteristic for a first component, acting in a first direction, of an acceleration acting in the common plane or in the parallel planes, and have mutually different response characteristics for a second component of the acceleration acting in a second direction perpendicular to the first component,
the method comprising the steps of:
obtaining data describing a deflection of the respective measuring points for at least one first and at least one second mass element or elastic support element,
eliminating the respective component of the acceleration acting in the first direction by evaluating the data collected from the respective measuring points of a first of the at least two first mass elements/elastic support elements and of the second mass element/elastic support element and by evaluating the data collected from the respective measuring points of the mass elements of a second of the at least two first mass elements/elastic support elements and the second mass element/elastic support element, and eliminating the component acting in the second direction by evaluating the two results adjusted for the component acting in the first direction,
recovering the components acting in the first and second direction by adjusting the result for the component acting in the second direction, and measuring the result adjusted for the components acting in the first and second directions as static acceleration and measuring the components acting in the first and second directions as dynamic acceleration.

62. The method of claim 61, wherein the device comprises at least two first mass elements and elastic support elements with measuring points and at least two second mass elements and elastic support elements with measuring points, the method comprising the steps of:
eliminating the component of the acceleration acting in the first direction by evaluating the data collected from the measuring points of a first of the at least two first mass/elastic support elements and of a first of the at least two second mass/elastic support elements and by evaluating the data collected from the measuring points of a second of the at least two first mass/elastic support elements and of a second of the at least one second mass element/elastic support element,
eliminating the component acting in the second direction by evaluating the two results adjusted for the component acting in the first direction, and
recovering the components acting in the first and second direction by adjusting the result for the component acting in the second direction, and
measuring the result adjusted for the components acting in the first and second direction as static acceleration and measuring the components acting in the first and second direction as dynamic acceleration.

63. The method of claim 60, wherein an angle of the at least one base plate is determined with respect to the static acceleration.

64. The method of claim 60, further comprising adjusting a signal level to eliminate acceleration components while leaving the characteristic features of a gravitational characteristic curve unaffected.

65. The method of claim 60, further comprising calibrating sensors by way of an iterative approximation using test algorithms when back-computed values for the vertical and the longitudinal acceleration for the sensors are in disagreement.

66. The method of claim 60, further comprising determining movement in an X-Y-Z coordinate system with at least two sensor blocks, with sensor planes enclosing an angle of 90° with one another.

67. The device of claim 39, wherein the device is used for at least one of:
determining at least one position parameter of at least parts of the device in space,
determining an acceleration component caused by gravity,
controlling processes
analysis of general movements of bodies,
analysis of a movement for associating with the movement a specific function,
analysis of a movement for performing a deliberate movement by technical means in a control loop,
determining a change in a position of an object,
determining an inclined position of an object,
stabilizing a position of an object, and
analyzing writing movements.

68. A computer program stored on a non-transitory computer readable storage medium, which enables a data processing device, after the computer program has been loaded into a memory of the data processing device, to carry out the method of claim 60.

69. A non-transitory computer readable storage medium, on which a program is stored which enables a data processing device, after the program has been loaded into a memory of the data processing device, to carry out the method of claim 60.

70. The method of claim 61, wherein an angle of the at least one base plate is determined with respect to the static acceleration.

71. The method of claim 61, further comprising adjusting a signal level to eliminate acceleration components while leaving the characteristic features of a gravitational characteristic curve unaffected.

72. The method of claim 61, further comprising calibrating sensors by way of an iterative approximation using test algorithms when back-computed values for the vertical and the longitudinal acceleration for the sensors are in disagreement.

73. The method of claim 61, further comprising determining movement in an X-Y-Z coordinate system with at least two sensor blocks, with sensor planes enclosing an angle of 90° with one another.

74. A computer program stored on a non-transitory computer readable storage medium, which enables a data processing device, after the computer program has been loaded into a memory of the data processing device, to carry out the method of claim 61.

75. A non-transitory computer readable storage medium, on which a program is stored which enables a data processing device, after the program has been loaded into a memory of the data processing device, to carry out the method of claim 61.

76. A computer program stored on a non-transitory computer readable storage medium which configures the device of claim 39 for separately measuring a static and a dynamic acceleration, after the computer program has been loaded into memory means of the device, enabling the device to:
determine at least one position parameter of at least parts of the device in space,
determine an acceleration component caused by gravity,
control processes
analyze general movements of bodies,
analyze a movement for associating with the movement a specific function,
analyze a movement for performing a deliberate movement by technical means in a control loop,
determine a change in a position of an object,
determine an inclined position of an object,
stabilize a position of an object, and
analyze writing movements.

77. A non-transitory computer-readable storage medium, on which a program is stored, which configures the device of claim 39 for separately measuring a static and a dynamic acceleration, after the computer program has been loaded into memory means of the device, enabling the device to:
determine at least one position parameter of at least parts of the device in space,
determine an acceleration component caused by gravity,
control processes
analyze general movements of bodies,
analyze a movement for associating with the movement a specific function,
analyze a movement for performing a deliberate movement by technical means in a control loop,
determine a change in a position of an object,
determine an inclined position of an object,
stabilize a position of an object, and
analyze writing movements.
